(19) United States
(12) Patent Application Publication
(10) Pub. No.: US 2011/0085339 A1
(43) Pub. Date: Apr. 14, 2011

(54) LED Lamp

(76) Inventor: Chang-Yao Lin, Jhongu City (TW)

(21) Appl. No.: 12/578,265

(22) Filed: Oct. 13, 2009

(51) Int. Cl. F21V 29/00

(52) U.S. Cl. 362/294; 362/373

(57) ABSTRACT

A light emitting diode (LED) lamp includes a lamp holder, an LED element installed to the lamp holder, a heat dissipating fin module installed at an external periphery of the lamp holder, and a plurality of heat pipes coupled between the lamp holder and the heat dissipating fin module. The heat pipe is provided for guiding waste heat of the lamp holder to the heat dissipating fin module for the heat dissipation to improve internal and external ambient temperatures of the lamp holder, so as to achieve the effects of maintaining a better thermal conductivity of the lamp holder for a long time, assisting a discharge of the waste heat of the LED, and maximizing an overall working performance of the LED lamp.

### BACKGROUND OF THE INVENTION

(a) Field of the Invention

The present invention relates to a heat dissipation technology of a light emitting diode (LED) lamp, and more particularly to an LED lamp structure having a better heat dissipating efficiency.

(b) Description of the Related Art

At present, the issue of energy saving becomes increasingly popular and governments of different countries prohibit the use of fluorescent bulbs. LED has the advantages of high efficiency, power saving, and dimmerability, LED lamps become a trend in the illumination market, and used extensively in many fields such as road lamps, automobile lamps, outdoor illuminations and mood lighting.

Even though the LED has so many advantages, it requires a number of LEDs operated at the same time to achieve the brightness and performance of illumination up to the level of a fluorescent bulb or a fluorescent tube. Therefore, a general LED lamp used for outdoor illumination comes with a design of fins installed at the exterior of the LED for dissipating heat by natural winds, rains or dews in order to solve the overheat issue of an LED chip.

If the LED is used for outdoor illumination (particularly for road lamps), different numbers of high-power LEDs are used as the light source, and thus a lamp holder for installing the LEDs will accumulate a large quantity of heat, so that the temperature at the top of the lamp holder will rise. If a fin module is integrated directly to the main body of the lamp holder, then the thermal conductivity of the lamp holder will be reduced significantly due to the difference between internal and external ambient temperatures of the lamp holder. As a result, the discharge of waste heat of the LED is affected adversely, and the using life of the LED is reduced.

### SUMMARY OF THE INVENTION

Therefore, it is a primary objective of the present invention to overcome the aforementioned shortcoming and deficiency of the prior art by providing an improved heat dissipating structure for an LED lamp, particularly for the application of an LED lamp structure used for outdoor illumination.

To achieve the foregoing objective, the present invention provides an LED lamp comprising a lamp holder, a heat dissipating fin module, and plurality of heat pipes, wherein the lamp holder is provided for installing an LED element, and the heat dissipating fin module is installed at an external periphery of the lamp holder, and the plurality of heat pipes are coupled between the lamp holder and the heat dissipating fin module.

The plurality of heat pipes are used for guiding waste heat of the lamp holder to the heat dissipating fin module for heat dissipation to improve the internal and external ambient temperatures of the lamp holder effectively, so that the lamp holder can be maintained at a better thermal conductivity for a long time, and the waste heat of the LED can be dissipated effectively, and the overall working performance of the LED lamp can be maximized.

### BRIEF DESCRIPTION OF THE DRAWINGS

FIG. 1 is a perspective front view of an LED lamp of the present invention;

FIG. 2 is an exploded view of an LED lamp of the present invention;

FIG. 3 is a schematic view of a heat pipe connected to a lamp holder and a heat dissipating fin module in accordance with the present invention;

FIG. 4 is another schematic view of a heat pipe connected to a lamp holder and a heat dissipating fin module in accordance with the present invention.

### DETAILED DESCRIPTION OF THE PREFERRED EMBODIMENTS

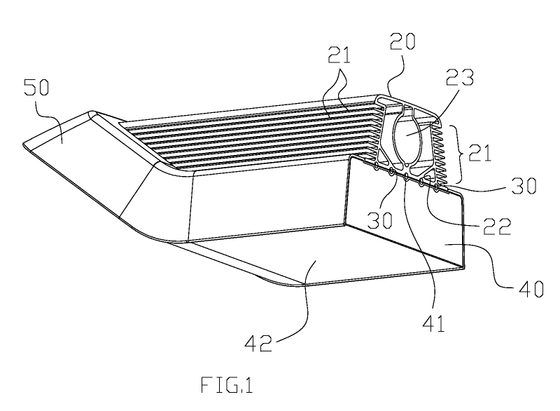

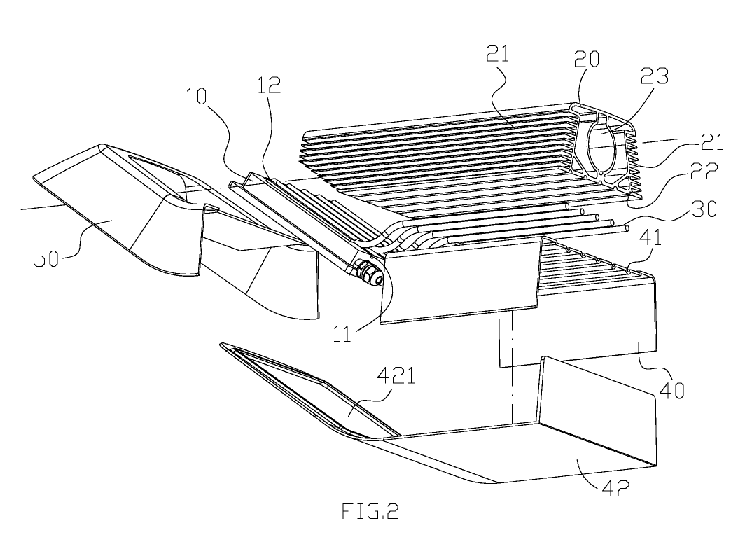

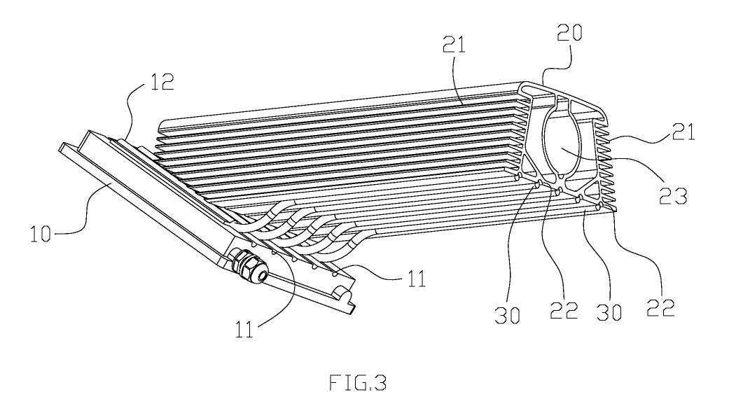

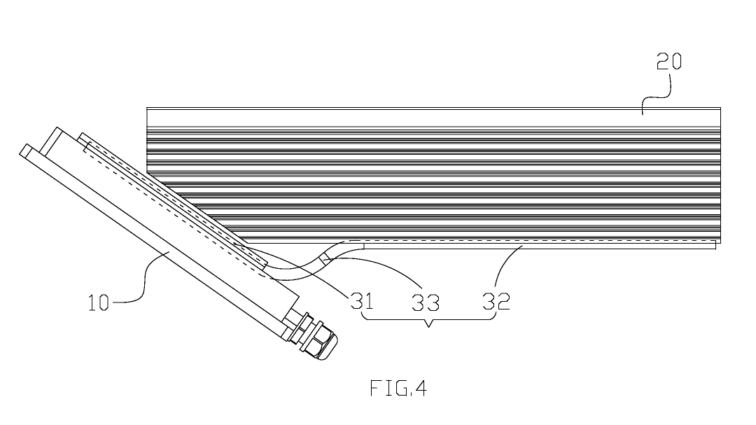

With reference to FIGS. 1 to 4 for an LED lamp of the present invention, the LED lamp comprises: a lamp holder 10, a heat dissipating fin module 20, and a plurality of heat pipes 30.

The lamp holder 10 is provided for installing an LED element (not shown in the figures), and made of aluminum or aluminum alloy. The lamp holder 10 includes a plurality of ditches 11 formed at the to of the lamp holder 10 for installing the heat pipes 30, and an upper casing 12 for pressing and fixing each heat pipe 30, and the lamp holder 10 is installed with an inclined angle such that light can be projected downwardly from the lamp holder 10.

The heat dissipating fin module 20 is installed at an external periphery of the lamp holder 10, and the heat dissipating fin module 20 is an aluminum extruded structure comprising a plurality of fins 21, a plurality of ditches 22 formed at the bottom of each fin 21 for installing a heat pipe 30, and a through hole 23 formed on a main body of the heat dissipating fin module 20 for passing through a lamp installing structure such as a lamp rod (not shown in the figures).

The plurality of heat pipes 30 are connected between the lamp holder 10 and the heat dissipating fin module 20, and pipes at both ends of each heat pipe 30 are installed into the lamp holder 10 and the corresponding ditches 11, 22 of the heat dissipating fin modules 20 respectively. In a preferred embodiment as shown in the figure, the heat pipe 30 includes a first contact portion 31 and a second contact portion 32, and a curved connecting portion 33 is provided for connecting the first and second contact portions 31, 32, and the first contact portion 31 is disposed in each ditch 11 of the lamp holder, and each ditch 11 is installed with an inclination. Of course, the first contact portion 31 can be installed with an inclination as well, and the second contact portion 32 is installed in each ditch 22 of the heat dissipating fin module, and each second contact portion 32 is installed horizontally. In the preferred embodiment, a case cover 40 is installed at the bottom of the heat dissipating fin module 20 and provided for accommodating a related control circuit, and the case cover 40 includes a plurality of ditches 41 formed at the top of the case cover 40 for installing the heat pipe 30, so that the plurality of heat pipes 30 can be clamped between the heat dissipating fin module 20 and the case cover 40.

In addition, the lamp holder 10 includes a lampshade 50 installed at the bottom of the lamp holder for fixing lamp holder 10, and an end of the lampshade 50 is coupled with the case cover 40, and the case cover 40 includes a lower casing 42 extended to the bottom of the lampshade 50, and the lower casing 42 includes a light exit hole 421 formed at a lower portion of the lampshade 50, such that the lampshade 50 and the case cover 40 becomes covering structures with better shielding effect, and better overall appearance and structure of the LED lamp.

When the LED lamp of the invention is operated, the plurality of heat pipes 30 guide the waste heat of the lamp holder 10 to the heat dissipating fin module 20 for dissipating the heat accumulated in the lamp holder 10 immediately, and improving the internal and external ambient temperatures of the lamp holder 10 effectively, such that the lamp holder 10 can be maintained at a good thermal conductivity for a long time to assist the dissipation of waste heat produced by the LEDs inside the lamp holder 10, and maximize the overall working performance of the LED lamp.

In summation of the description above, the present invention overcomes the shortcomings of the prior art and complies with patent application requirements, and thus is duly applied for patent application,

While the invention has been described by means of specific embodiments, numerous modifications and variations could be made thereto by those skilled in the art without departing from the scope and spirit of the invention set forth in the claims.

I claim:

1. A light emitting diode (LED) lamp, comprising:
a lamp holder, provided for installing an LED element, and having a plurality of ditches formed at the top of the lamp holder;
a heat dissipating fin module, installed at an external periphery of the lamp holder, and having a plurality of ditches formed at the bottom of the heat dissipating fin module;
a plurality of heat pipes, coupled between the lamp holder and the heat dissipating fin module, and each heat pipe having a first contact portion and a second contact portion, a curved connecting portion disposed and connected between the first and second contact portions, and the first contact portion being disposed in each ditch of the lamp holder, and the second contact portion being disposed in each ditch of the heat dissipating fin module.

2. The LED lamp of claim 1, wherein the lamp holder includes an upper casing for pressing and fixing each heat pipe.

3. The LED lamp of claim 1, wherein the heat dissipating fin module includes a through hole formed on a main body of the heat dissipating fin module and provided for passing a lamp installing structure through the through hole.

4. The LED lamp of claim 1, wherein the heat dissipating fin module includes case cover installed at the bottom of the heat dissipating fin module for accommodating a related control circuit.

5. The LED lamp of claim 1, wherein the heat dissipating fin module includes a case cover installed at the bottom of the heat dissipating fin module for accommodating a related control circuit, and a plurality of ditches formed at the bottom of the heat dissipating fin module for placing the heat pipes, and the case cover includes a plurality of ditches formed at the top of the case cover for placing the heat pipes.

6. The LED lamp of claim 1, wherein the lamp holder includes a lampshade installed at the bottom of the lamp holder.

7. The LED lamp of claim 1, wherein the heat dissipating fin module includes a case cover installed at the bottom of the heat dissipating fin module for accommodating a related control circuit, and the lamp holder includes a lampshade installed at the bottom of the lampshade, and an end of the lampshade is coupled to the case cover, and the case cover includes a lower casing extended to the bottom of the lampshade, and the lower casing includes a light exit hole formed at a position opposite to the bottom of the lampshade.

8. The LED lamp of claim 1, wherein the lamp holder is installed with an inclination, such that a light from the LED element can be emitted slantingly downward.

9. The LED lamp of claim 8, wherein the lamp holder is installed with an inclination, and the first contact portion together with each ditch is formed with an inclination, and each second contact portion is disposed horizontally.
